(19) United States
(12) Patent Application Publication
(10) Pub. No.: US 2022/0255374 A1
(43) Pub. Date: Aug. 11, 2022

(54) STATOR WITH LIQUID-COOLED STATOR CORE

(71) Applicant: NIDEC GPM GmbH, Auengrund OT Merbelsrod (DE)

(72) Inventor: Franz PAWELLEK, Lautertal (DE)

(21) Appl. No.: 17/615,024

(22) PCT Filed: May 27, 2020
(86) PCT No.: PCT/EP2020/064660

§ 371 Date: Nov. 29, 2021

(30) Foreign Application Priority Data
May 28, 2019 (DE) 10 2019 114 264.4

(51) Int. Cl. H02K 1/20; H02K 1/16

(52) U.S. Cl. CPC H02K 1/20; H02K 1/165

(57) ABSTRACT

A stator of a brushless DC motor includes a stator core with stacked stator laminations each including an annular surface and stator teeth evenly spaced in a circumferential direction about a longitudinal axis of the stator and each including a tooth root and a tooth head. Current-carrying windings defining coils are on the tooth bases of the stator core. The stator core includes three different types of the stator laminations which include corresponding openings cooperating to define cooling channels each extending parallel or substantially parallel to the longitudinal axis from one end to another of the stator core.

### CROSS REFERENCE TO RELATED APPLICATIONS

This is a U.S. national stage of PCT Application No. PCT/EP2020/064660, filed on May 27, 2020, and with priority under 35 U.S.C. § 119(a) and 35 U.S.C. § 365(b) being claimed from German Application No. 10 2019 114 264.4, filed May 28, 2019, the entire disclosures of which are hereby incorporated herein by reference.

### 1. FIELD OF THE INVENTION

The present disclosure relates to a stator, and to a brushless DC motor.

### 2. BACKGROUND

Brushless DC motors include a rotor which is connected to a motor shaft and rotatably mounted in a housing. The rotor is provided with permanent magnets. A stator is arranged around the motor, which carries a number of windings on an iron core. When suitably driven, the windings generate a magnetic field which drives the rotor to rotate. The stator core is formed from at least one stack of laminations including a plurality of stator laminations.

Electric motors with high specific power are limited in power output by their self-heating. The heat loss in the stator arises specifically from the ohmic resistance of the winding. The heat loss is dissipated through the iron core. However, the maximum heat dissipation is limited by the limited thermal conchannelivity of the stator laminations and the partially large distance between the place of heat generation and the iron core.

From the prior art, cooling systems integrated in the stator lamination package are known, in which tubes are inserted into bores in the stator lamination, through which coolant then flows and which form a closed cooling system. Such a cooling system is disclosed, for example, in DE 197 57 605 A1. In order to establish a connection to the metal sheets, the tubes are usually press-fitted or glued. In any case, joints remain which represent an increased thermal resistance due to the low conchannelance. In addition, an increased sheet cross-section is required for the integration of the tubes.

### SUMMARY

Example embodiments of the present disclosure provide stators, each of which can be cooled efficiently and with little effort.

For the purpose of the geometrical description of electric motors according to example embodiments of the present disclosure, an axis of rotation of the motor is assumed to be the central axis and the axis of symmetry. The stator is concentric with the axis of rotation and the rotor. The axis of rotation simultaneously defines a longitudinal axis of the stator and the stator core. Moreover, with respect to the longitudinal axis, it is spoken of a radial direction, which indicates the distance from the longitudinal axis, and a circumferential direction, which is defined tangentially to a certain radius extending in the radial direction.

A stator of a brushless DC motor includes a stator core with stacked stator laminations each including an annular surface and multiple stator teeth, the stator teeth being evenly spaced in a circumferential direction about a longitudinal axis of the stator and each including a tooth root and a tooth tip. Energizable windings defining coils are provided on the tooth roots of the stator core. The stator core includes three different types of stator laminations including partially corresponding openings cooperating to define cooling channels. Each of the cooling channels extends substantially parallel to the longitudinal axis from one end of the stator core to another end of the stator core.

The cooling channels allow efficient cooling of the stator with a simple structure of the stator package. A liquid coolant can preferably flow through the cooling channels. The cooling channels are preferably designed in such a way that they allow a sufficient cooling volume flow to pass at a pressure of about 2 bar, for example.

Preferably, two types of stator laminations include openings in an area of the tooth root. The coolant can thus be guided particularly close to the point of heat generation.

Preferably, the annular surfaces of the stator laminations define a stator base body. The cooling channels are each branched off several times into a side channel from a main channel extending parallel to the longitudinal axis in the stator base body, the side channel in each case projecting perpendicularly from the main channel into an individual tooth root and structured to lead back to the main channel via a deflection. The coolant is guided in a targeted manner via the side channels.

In this case, it is advantageous if sub-regions of a side channel connected via the inversion are spaced apart from one another in the longitudinal direction and extend parallel to one another, the sub-regions each including at least two stator laminations which are of the same type. Since both sub-regions are defined by the same type of stator lamination, the number of types of stator lamination can be kept to a minimum.

Preferably, another type of stator lamination provides the deflection. Preferably, each deflection is defined by a single stator lamination. The last type of stator lamination preferably defines the main channel. Preferably, the stator laminations defining the sub-portions also have an opening in the region of the main channel, so that they also define a portion of the main channel.

In an example embodiment, each stator tooth includes a single cooling channel. The cooling guide is thus symmetrical, and each stator tooth has the same cooling conditions.

It is advantageous if each cooling channel includes a mirror plane in which the longitudinal axis of the stator core lies and which is identical to a mirror plane of the corresponding stator tooth. This example embodiment achieves a uniform cooling of each tooth.

Preferably, the openings of the stator laminations have the same width tangential to the longitudinal axis.

The stator teeth of the stator can be provided on the outside or inside of the stator base body, depending on the application.

In an example embodiment, all stator laminations have the same thickness (i.e., a length in the longitudinal direction).

Further provided is a brushless DC motor including a rotor mounted to rotate about the longitudinal axis and a stator as previously described. The cooling system may include an external pump. The pump generates a volume flow which is used to cool the stator teeth. Preferably, the coolant is first passed through the cooling channels in the stator and then sprayed onto the outside of the stator teeth. However, the cooling system may also include an internal pump in the DC motor. Preferably, the required pressure is generated by a centrifugal pump on the rotor shaft.

The cooling fluid is preferably an oil or an inert fluid to prevent corrosion, and can be, for example, nitrogen, argon, helium or carbon dioxide in the fluid state, which is preferably designed for direct cooling of electronic components.

The brushless DC motor can be used in pumps, for example, provided that the pumping medium does not have a corrosive effect on the stator. Gear oils or other hydrocarbon-based fluids would be suitable, for example. An application in traction motors is also advantageous.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 shows a top view of a stator core of an internal rotor electric motor.

FIG. 2 shows a longitudinal section through the stator core of FIG. 1 along line A-A.

FIG. 3 shows a detailed view of the longitudinal section of FIG. 2.

FIG. 4 shows top views of a partial area of the stator laminations numbered in FIG. 3.

### DETAILED DESCRIPTION

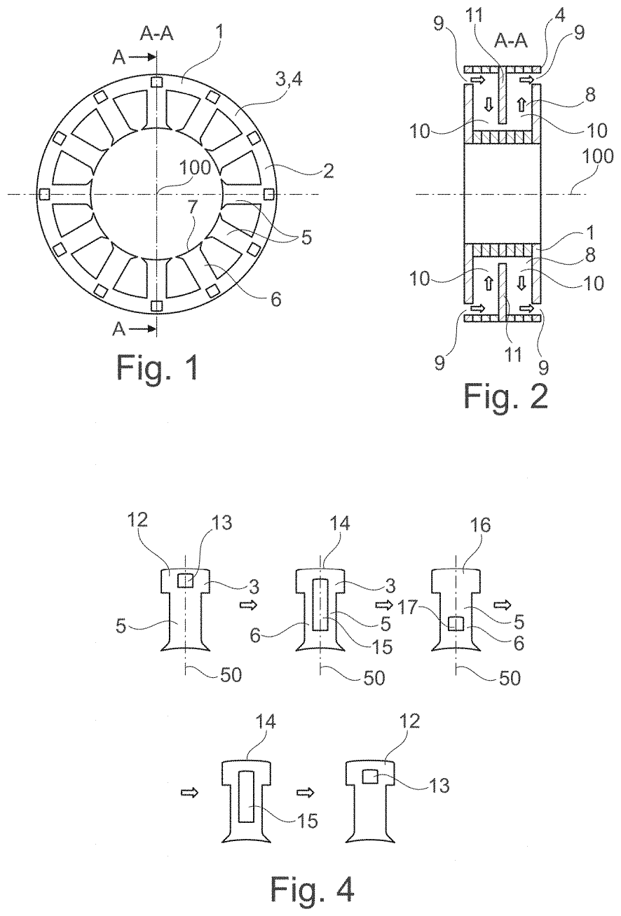

FIG. 1 shows a stator core 1 of a stator of an internal rotor electric motor. The stator core 1 extends coaxially with respect to a longitudinal axis 100. The stator core 1 is formed from a plurality of stator laminations 2 stacked one on top of the other in the direction of the longitudinal axis 100. Each lamination 2 has an annular surface 3 which, when the stator core 1 is assembled, forms a stator base body 4. Evenly spaced stator teeth 5 are provided on the inner side of the stator base body 4 circumferentially around the longitudinal axis 100, which teeth extend inwardly in radial direction. The stator teeth 5 are formed in the laminations 2 in one piece with the annular surface 3. The stator teeth 5 each have a tooth root 6 and a tooth head 7. The tooth base 6 extends from the stator base body 4 or the annular surface 3 in the radial direction and merges with the tooth head 7. The tooth head 7 has a greater width in the circumferential direction than the tooth root 6. Coils, at least some of which are not shown, are wound on the tooth bases 6 of the stator teeth 5. The tooth heads 7 define and secure the position of the windings on the stator teeth 5. The stator is fixedly mounted within a housing of the electric motor and is adapted to generate a time-varying magnetic field by means of the coils. A magnetized rotor, not shown, is thereby mounted in the central opening of the stator core 1. It is arranged to be rotated by an interaction with the time-varying magnetic field generated by the coils.

As shown in FIG. 2, the stator core 1 has cooling channels 8 through which a cooling medium flows along the arrows to remove heat. The main flow direction of the cooling channels 8 is parallel to the longitudinal axis. Each cooling channel 8 comprises a main channel 9 extending parallel to the longitudinal axis 100 and side channels 10. The main channels 9 are arranged in the stator base body 4. They are evenly spaced in the circumferential direction and arranged at the level of each stator tooth 5. The main channels 9 are not continuous in the longitudinal direction 100. They have interruptions which are formed by webs 11 projecting inwards into the main channel 9 in the radial direction. The side channels 10 connect the individual sections of each main channel 9. They extend around a web 11. The side channels 10 thus have a deflection which is approximately U-shaped. In this respect, it is preferable from a manufacturing point of view if the angles of the deflection are approximately rectangular. The coolant thus flows back and forth along the longitudinal axis 100 and at uniform intervals in the radial direction. The channel cross-section or flow cross-section of the sections extending parallel to the longitudinal axis 100 is thereby constant. The channel sections running perpendicularly thereto also have a constant flow cross-section.

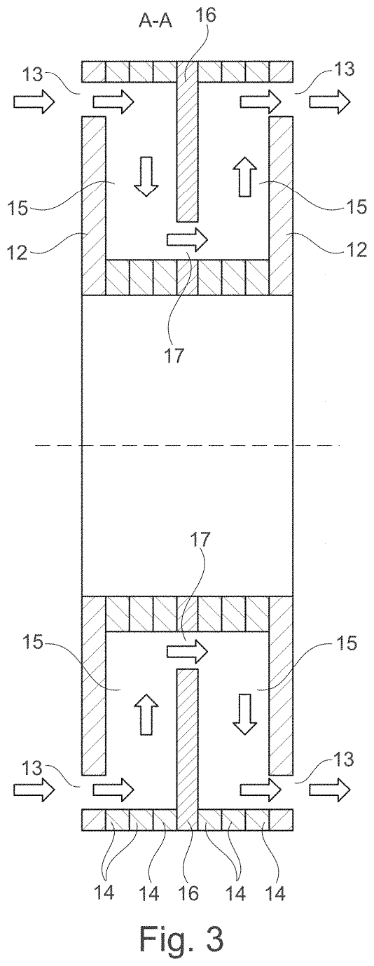

FIGS. 3 and 4 show three different types of stator laminations 2 which, when assembled together in the stator pack, form the cooling channels 8.

A first type of stator lamination 12 has a first rectangular, approximately square opening 13 located in the annular surface 3. The first opening 13 has a mirror plane, which is preferably identical to a mirror plane 50 of the tooth 5. The first type of stator lamination 12 forms the main channel 9.

A second type of stator lamination 14 has a second, rectangular, radially aligned longitudinal opening 15. The second opening 15 extends from the annular surface 3 along the tooth root 6. The mirror plane of the second opening 15 is preferably identical to the mirror plane 50 of the tooth 5. The second opening 15 is formed such that, when the stator laminations are assembled to form a stator pack, the first opening 13 is aligned with the second opening 15 at its end near the annular surface and the openings thus partially correspond. The second type of stator laminations 14 forms the side channel 10.

The third type of stator lamination 16 has a third, rectangular, approximately square opening 17 in the region of the tooth root 6. The third opening 17 has a mirror plane, which is preferably identical to the mirror plane 50 of the tooth 5. The third type of stator lamination 16 forms the deflection of the side channel 10. The third opening 17 is formed such that when the stator laminations 2 are assembled to form a stator pack, the third opening 17 is aligned with the second opening 15 at its end near the tooth tip.

In the assembled state of the stator pack, only a single stator lamination of the first type 12 is used as initial and final lamination for each section. In between, a plurality of stator laminations of the second kind 14 are arranged, in the middle of which a single stator lamination of the third kind 16 is received. The assembled stator pack has a plurality of sections. The sequence or arrangement of the stator laminations is then repeated accordingly. The openings in the stator laminations 13,15,17 form coolant channels 8. Since only three different types of stator laminations 12,14,16 are used, the stator core is inexpensive to manufacture.

The cooling channels 8 have a large surface area for efficient heat dissipation. In addition, they have been shown to ensure a uniform distribution of the magnetic flux. In addition, the channel geometry allows a high flow velocity, with acceptable flow losses in terms of volume flow and pressure loss.

The cooling medium is a liquid, which is preferably an oil or an inert fluid to prevent corrosion, wherein the inert fluid can be, for example, nitrogen, argon, helium or carbon dioxide in the fluid state, which is preferably designed for direct cooling of electronic components.

The stator shown in the figures is part of an internal rotor electric motor. However, it may also be envisaged that the stator is an internal stator circumferentially surrounded by an external rotor. In such an example embodiment, the teeth of the stator core project radially outwardly, away from the longitudinal axis of the stator.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12. A stator of a brushless DC motor, the stator comprising:
a stator core including stacked stator laminations each including an annular surface and stator teeth each being evenly spaced in a circumferential direction about a longitudinal axis of the stator and including a tooth root and a tooth head; and
current-carrying windings defining coils and provided on the tooth roots; wherein
the stator core includes three different types of the stacked stator laminations which include corresponding openings which cooperate to define cooling channels, each of the cooling channels extending parallel or substantially parallel to the longitudinal axis from one end of the stator core to another end of the stator core;
each of the cooling channels includes a main channel extending parallel or substantially parallel to the longitudinal axis and side channels, the main channels being provided in a stator base body and spaced in the circumferential direction and level with each of the stator teeth;
the main channels include interruptions in a longitudinal direction and the side channels connect individual sections of each of the main channels; and
the side channels project perpendicularly or substantially perpendicularly from the main channels into an individual ones of the tooth roots and lead back to the main channel via a deflection.

13. The stator according to claim 12, wherein in two of the three different types of the stator laminations, the openings are located in the tooth roots.

14. The stator according to claim 12, wherein sub-regions of one of the side channels connected via the deflection are spaced apart from one another in the longitudinal direction and extend parallel or substantially parallel to one another, the sub-regions are defined by at least two of the stator laminations which are of the same type.

15. The stator according to claim 12, wherein a single type of the three different types of the stator laminations define the deflection.

16. The stator according to claim 12, wherein a single type of the three different types of the stator laminations define the main channel.

17. The stator according to claim 12, wherein each of the cooling channels includes multiple ones of the deflection which are spaced in the longitudinal direction.

18. The stator according to claim 12, wherein the deflection is defined by a single stator lamination.

19. The stator according to claim 12, wherein each of the stator teeth includes a single one of the cooling channels.

20. The stator according to claim 12, wherein each of the cooling channels includes a mirror plane in which the longitudinal axis of the stator core lies and which is identical to a mirror plane of a corresponding one of the stator teeth.

21. The stator according to claim 12, wherein the openings of the three different types of the stator laminations have a same width extending tangentially to the longitudinal axis.

22. A brushless DC motor comprising:
the stator according to claim 12; and
a rotor rotatably mounted about the longitudinal axis
